(19) United States
(12) Patent Application Publication
(10) Pub. No.: US 2012/0025551 A1
(43) Pub. Date: Feb. 2, 2012

(54) UPRIGHT SHOVEL AND METHOD OF USE

(76) Inventor: Richard JANOSKY, Exeter, PA (US)

(21) Appl. No.: 12/848,160

(22) Filed: Jul. 31, 2010

(51) Int. Cl. A01B 1/02; E01H 5/02

(52) U.S. Cl. 294/53.5

(57) ABSTRACT

The present invention relates to an upright shovel to relocate snow or dirt from one location to another. The upright shovel enables a person to shovel snow while standing up straight, without requiring them to repeatedly bend over to lift a pile of snow. The upright shovel features a fulcrum lift system specifically designed for multiplying the mechanical force associated with lifting and unloading snow in a safe and efficient manner. A user pushes down against an actuator shaft to engage a fulcrum bar under a blade. A tip of the blade lifts a load because, attached above the fulcrum bar, is a hinge attached to a support shaft which remains stationary while the actuator shaft moves. Accordingly, when the actuator shaft is raised the tip of the blade lowers to releasing the load.

### BACKGROUND OF THE INVENTION

1. Field of the Invention

The present invention relates to an upright shovel to enable a user to transport a load by utilizing a pair of shafts attached to a blade on the upright shovel which engage a fulcrum bar at a pivot to lift and lower the blade without requiring the user to bend over while trying to lift the load.

2. Description of Related Art

Commonly, shovels are tools used to relocate snow, dirt, rocks or the like from one place to another. The shovel enables a person to scoop a load onto the blade and temporarily carry it either to a new location or into some sort of holding device, like a wheelbarrow or bucket. A basic shovel includes an elongated shaft attached to a scooping blade, and functions as a simple lever to lift and lower the load. The person secures the blade below a portion of the load, and adjusts their hands at two places on the shaft. One hand may be placed towards the middle of the shaft as a fulcrum or pivot, and the opposite hand gripping the end of the shaft to push and apply a force. As the person pushes the end of the shaft against the weight of the load, the blade will lift about the pivot to lift the load.

While shovels are simple tools, designed to aid a person doing work, they include inherent problems to use. The most blaring problem is how much strain is put on a person's back when lifting and carrying a load. Typically the person must repeatedly lean or bend and then straiten with the heavy load in their hands. The weight carried on the blade may put stain and undue stress on the muscles of the person's back, which in turn may cause permanent damage or back problems if the person continuously performs the bending and straightening motions. For this reason, many people are unable to use a basic shovel due to the burden associated with lifting the load.

It would be desirable in the art to have a shovel which could enable a person to stand upright while lifting and lowering the load. It would also be beneficial to enable the person to easily and efficiently use the tool without undue strain exerted on their bodies.

### SUMMARY OF THE INVENTION

The present invention discloses an upright shovel comprising an actuator shaft, a actuator handle fastened to an upper portion of the actuator shaft, a pivot assembled to a lower portion of the actuator shaft, a fulcrum bar connected to the pivot, a blade where a backside of the blade is attached to the fulcrum, a tip at an end of the blade, a support shaft positioned in front of the actuator shaft, a hinge at a lower end of the support shaft where the hinge is attached to the backside of the blade, above where the fulcrum bar is attached, a slide opening at an upper portion of the support shaft to accept the actuator shaft through the slide opening to the actuator handle, a support bar extending from the slide opening behind the actuator shaft, a support handle at a distal end of the support bar; and a dividing bar within the slide opening positioned in front of the actuator shaft wherein when the actuator shaft is pushed down by a user the fulcrum bar is engaged at the pivot to lift the tip of the blade, and in turn when the actuator bar is raised by the user, the fulcrum bar releases and the tip of the blade is lowered.

The upright shovel enables a person to shovel snow while standing up straight, without requiring them to repeatedly bend over to lift a pile of snow. The upright shovel features a fulcrum lift system specifically designed for multiplying the mechanical force associated with lifting and unloading snow in a safe and efficient manner.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawing and descriptive matter in which there are illustrated exemplary embodiment of the present invention.

### BRIEF DESCRIPTION OF THE DRAWINGS

The advantages and features of the present invention will become better understood with reference to the following detailed description and claims taken in conjunction with the accompanying drawing, wherein like elements are identified with like symbols, and in which:

FIG. 1 is a perspective view of an upright shovel in accordance with an exemplary embodiment of the present invention.

### DETAILED DESCRIPTION OF THE DRAWINGS

The present invention relates to an upright shovel to relocate snow or dirt from one location to another. The upright shovel enables a user to stand erect while shoveling, rather than continuously bending and straightening to scoop, lift and dump the snow. By allowing the user to stand up straight, the upright shovel prevents excessive back strain and physical injuries normally caused by conventional shovels, thus individuals prone to back injuries and the like may use the upright shovel without undue exertion. As such the upright shovel may be utilized by commercial and residential users to provide safer and more efficient means of shoveling.

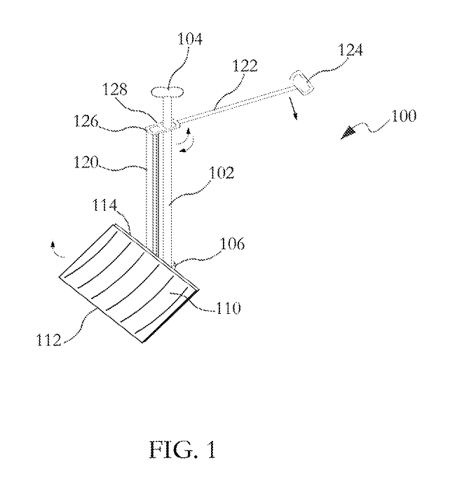

Turning now descriptively to the drawings, referring to FIG. 1, a perspective view of an upright shovel (100) is shown in accordance with an exemplary embodiment of the present invention. The upright shovel (100) may include an actuator shaft (102), an actuator handle (104) and a pivot (106). The actuator shaft (102) extends from the actuator handle (104) at a top portion of the upright shovel (100) to the pivot (106) at a lower portion of the upright shovel (100). The actuator shaft (102) may have a round or tubular shape to enable a user to rotate the shaft (102) at the handle (104). At the lower end of the upright shovel (100), may be a blade (110) comprising a tip (112) and a back scoop (114). The pivot (106) may attach to a fulcrum bar (not shown) which in turn may attach to a backside of the blade (110).

In front of the actuator shaft (102) may be a support shaft (120). A lower end of the support shaft (120) may be connected to a hinge (not shown) on the backside of the blade (110) above where the fulcrum bar is attached. The hinge may enable the tip (112) of the blade (110) to raise and lower in relation to the back scoop (114) when the actuator shaft (102) pushes against the fulcrum bar at the pivot (106). The support shaft (120) extends from the hinge up to a slide opening (126) at an upper portion. Extending from the slide opening (126) may a support bar (122) which ends at a support handle (124). The slide opening (126) may be divided into two portions by a dividing bar (128). The actuator shaft (102) may fit through the slide opening (126) behind the dividing bar (128). The support shaft (102) may be straight (as shown) or curved to gradually transition into the support bar (122).

To shovel, a user may hold onto the actuator handle (104) with one hand and the support handle (124) with another hand. The user may lift the actuator shaft (102) with the actuator handle (104) within the slide opening (126). Next the user may brace the upright shovel (100) against a load with the tip (112) of the blade (110), and then push down on the actuator handle (104). The load may be a pile of snow, a clump of dirt, a bunch of rock or another type of load typically carried by a shovel. As the actuator handle (104) lowers the actuator shaft (102), the pivot (106) may engage the fulcrum bar to lift the tip (112) of the blade (110) with a mound of snow resting against the back scoop (114). The support shaft (120) and the support bar (122) may remain stationary as the actuator shaft (102) raises and lowers. The mound of snow may then be carried to another location, and dumped by lifting the actuator handle (104). All the while the user does not have to bend over and risk potentially hurting their back when trying to shovel the snow. They may stand in an upright position to hold the support handle (124) and move the actuator handle (104) up and down. The upright shovel (100) may be adapted to accommodate a variety of user specifications when varying the height of the shafts (102 and 120), the length of the support bar (122) or the width of the blade (110).

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An upright shovel comprising:
an actuator shaft;
a actuator handle fastened to an upper portion of the actuator shaft;
a pivot assembled to a lower portion of the actuator shaft;
a fulcrum bar connected to the pivot;
a blade where a backside of the blade is attached to the fulcrum;
a tip at an end of the blade;
a support shaft positioned in front of the actuator shaft;
a hinge at a lower end of the support shaft where the hinge is attached to the backside of the blade, above where the fulcrum bar is attached;
a slide opening at an upper portion of the support shaft to accept the actuator shaft through the slide opening to the actuator handle;
a support bar extending from the slide opening behind the actuator shaft;
a support handle at a distal end of the support bar; and
a dividing bar within the slide opening positioned in front of the actuator shaft wherein when the actuator shaft is pushed down by a user the fulcrum bar is engaged at the pivot to lift the tip of the blade, and in turn when the actuator bar is raised by the user, the fulcrum bar releases and the tip of the blade is lowered.

2. The upright shovel of claim 1, wherein the actuator shaft has a tubular shape to rotate within the slide opening.

3. The upright shovel of claim 1, wherein the blade includes a back scoop at an opposite end of the tip to enable a load to rest on top of the blade without sliding.

4. The upright shovel of claim 3, wherein the load is a pile of snow, a clump of dirt or a bunch of rocks.

5. A method for using an upright shovel comprising the steps of:
holding an actuator handle attached to an actuator shaft in one hand;
holding a support handle attached to a support shaft in another hand wherein the support shaft connects to a backside of a blade with a hinge;
lifting the actuator handle;
bracing a tip of the blade of the upright shovel against a load;
pushing down on the actuator handle to lower the actuator shaft against a pivot;
engaging a fulcrum bar fixed to the pivot, attached on the backside of the blade below the hinge, to raise the tip of the blade thus scooping the load onto the blade;
carrying the load to a desired location; and
dumping the load at the desired location by lifting the actuator handle to lower the tip of the blade.
